(19) United States
(12) Patent Application Publication
(10) Pub. No.: US 2012/0194738 A1
(43) Pub. Date: Aug. 2, 2012

(54) DUAL MODE PROJECTION DOCKING DEVICE FOR PORTABLE ELECTRONIC DEVICES

(76) Inventors: Yongjing Wang, Valencia, CA (US); James Lupino, Hurley, WI (US)

(21) Appl. No.: 13/359,340

(22) Filed: Jan. 26, 2012

Related U.S. Application Data
(60) Provisional application No. 61/436,492, filed on Jan. 26, 2011.

(51) Int. Cl. H04N 9/31; H04W 88/02; H04N 5/63

(52) U.S. Cl. 348/552; 348/730; 348/E09.025; 348/E05.127

(57) ABSTRACT

A dual mode projection display apparatus for portable electronic device comprises: a projection device, a built-in screen, an input device and a wired or wireless connector to said portable electronic device. It has dual operation mode: in the first mode, it produces an image onto the built-in screen; in the second mode, it produces an image onto any external surface with substantially high reflectance/scattering. When connected with a smartphone, the apparatus provides a big screen and convenience input method for the user. The invention increases the functionality and utility of a smartphone.

### CROSS-REFERENCE TO RELATED APPLICATIONS

This application claims priority of Provisional Patent Application No. 61/436,492 having a filing date of Jan. 26, 2011.

### TECHNICAL FIELD

The invention generally pertains to an output and input system for portable electronic devices and more particularly to a new docking system based on a dual mode projection device and keyboard.

### BACKGROUND ART

With the advance of microelectronics and the cloud computing infrastructure, smartphones have become more and more powerful. Their processing power has reached the similar level of a notebook computer or even a desktop computer. The smartphone is becoming the single computing device of choice for consumers and professionals. Due to the portability requirement of smartphones, their screen and keyboard have been limited in size to about 4 to 5 inches. The small screen size and keyboard limit the utility of smartphones from applications normally found on notebook and tablet PCs.

Motorola and Celio corporation have developed docking stations with direct view LCD and a keyboard for smartphones. U.S. Pat. No. 7,266,391 B2 and U.S. Pat. No. 7,076,270 B2 both disclose methods to expand the screen of a portable electronic device by using direct view LCD display in a user-friendly productive notebook type fashion. However, direct view LCDs are limited in their efficiency and weight. Also the screen size of display is limited to about 12 inches.

Projection display technology has advanced in recent years such that their size and weight have reached the stage that incorporation of such devices in portable devices has occurred. Such ‘pico-projectors’ are envisioned to ultimately be embedded into smartphones to enable a larger screen display for the user. Several handheld or tethered pico-projector products are available in the marketplace including devices from such firms including 3M, Aiptek, Microvision, and others. One of the problems of pico-projectors is the requirement that a usable surface must be available for the projection display. In a conference room or in the home, this may not be a problem; however, in public spaces such as when a person is on travel for business or otherwise, finding a suitable projection screen is difficult at best. Furthermore, although the stand-alone tethered pico-projector provides at times for larger display of the smartphone display, it does not contribute to improving productivity of the data input function on the limited keyboard and screen size of the smartphone.

As a result, there exists a current need for a device to provide a versatile screen size from 10 inch to 100 inches for a smartphone as well as an input device all in a user-friendly mode productivity enhancing device. Such a device should be highly efficient thus sustain a long battery life and should be super portable.

A search of the prior art did not disclose any patents that read directly on the claims of the instant invention, however the following patents and publications are considered related:

| PATENT NO. | INVENTOR | ISSUED |
|---|---|---|
| U.S. Pat. No. 7,076,270 | Jaggers | Jul. 11, 2006 |
| U.S. Pat. No. 7,266,391 | Warren | Sep. 4, 2007 |
| U.S. Pat. No. 5,483,250 | Herrick | Jan. 9, 1996 |
| PUBLICATION NO. | INVENTOR | FILING DATE |
| EP 0 888 005 A2 | Tappara | Aug. 6, 1998 |

### DISCLOSURE OF THE INVENTION

The present invention discloses an apparatus that provides large screen output display and a method for improved input for portable electronic devices, mainly for smartphones that have significant processing power. The apparatus comprises:

1) Projection display device;

2) A built in projection screen;

3) A means for communicating via wired or wireless methods with a smartphone;

4) A power supply and mechanism parts.

In one embodiment, the projection screen is one piece monolithic rigid screen. In an alternative embodiment, the projection screen is of the type that can be rolled up or folded into a compact size to further reduce the carry-on size of the system.

A key object of the invention is to provide an ultra-portable device which is highly efficient in power consumption. Hence, compared to flat panel display technology such as direct view LCDs, projection display provides similar brightness on a notebook size (9-15″) display for at least a 70% reduction in power consumption. Therefore, projection technology is ideally suited for ultra-low power consuming displays. The added advantage of projection is the ability to project at different sizes depending on the projection screen options available.

In one embodiment, the apparatus further comprise a moveable mechanism that can switch the projector from projecting onto the built-in projection screen to projecting onto an external screen or wall surface. The projector works in dual modes. In the first projection mode, the apparatus produces a notebook-sized image onto the built-in projection screen for the single user. The built-in screen may be either a rear projection screen or front projection screen, the size of which may be, but is no limited to, 9 to 15 inches. In the second projection mode, the apparatus produces up to a 100 inch screen for multiple users onto an external projection surface not built into the apparatus. Such external projection surface may be front projection screen, a wall or other surface, or rear projection screen

The projection lens of the projection display device is specially designed to produce a large image at short throw distance. The projection lens is characterized as a short focal length lens. The throw ratio (R) is defined as the throw distance (L) over the width of the image (W). R=L/W. The drawbacks of short focal length lens are 1) it typically has a large size; 2) it is more difficult to design therefore its cost is high. Therefore in conventional pico projection technology, the short focal length lens has not been used. In the apparatus in the present invention, the projection lens produces a large image within short projection distance. Hence, a lower throw ratio from 0.1 to 5 is preferred.

In one embodiment, the apparatus further comprises a keyboard for the user to input information productively. In an alternative embodiment, the keyboard is a touch panel keyboard. In another embodiment, the keyboard layout is projected out by a projector and an image sensor is used to detect the movement of finger to register the input keys.

The mechanism in the present invention is designed to keep all components in a very compact package when the system is not operated and to ensure the display screen and projector are at the right positions when the system is in use.

The apparatus further is characterized by its electronic system without CPU, and operating system (OS). The apparatus cannot be used as a stand alone device. It becomes functional only after connected with a portable electronic device like a smartphone. The projection display and keyboard both connect with the smartphone either via hard wire or wireless connection.

The apparatus includes a receiver which receives video signals from said portable electronic device. The signal represents mirroring image of the display screen on the portable electronic device. In another alternative the dual mode projection system described herein may be applicable to other display applications including but not limited to TVs and monitors which provide a video signal to the projection display apparatus without requiring a smartphone or keyboard.

Accordingly, there are several objects or advantages of the invention. The objects or advantages are:
(a) Providing full notebook user-friendly productive experience for smartphone users.
(b) Achieving higher brightness and contrast by using built-in rear projection screen.
(c) Providing large display using external projection screen mode.
(d) Super thin, light weight and ultra-low power
(e) Ultra-low cost CMOS-based multi-touch screen

Further objects or advantages to the users are the invention is a true Green “Light” product because 1) users need not acquire duplicate computing and bandwidth resources as required in a notebook or tablet PC, 2) no data synchronization is needed between smartphone and computer, 3) picoprojection technology provides the highest power efficiency for display of notebook size images at high brightness, and 4) users need not acquire a separate projection display for large screen projection. The invention enables a super smartphone for all applications.

Further objects and advantages will become apparent from the following description and accompanying drawings. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

FIG. 1: (a) First embodiment working in first projection mode with a rear-projection screen configuration (b) First embodiment working in the second projection mode projecting on a wall surface

FIG. 2: Second embodiment with a touch screen based an image sensor

FIG. 3: Third embodiment with a touch screen keyboard

FIG. 4: Fourth embodiment with a projection keyboard

### BEST MODE FOR CARRYING OUT THE INVENTION

The best mode for carrying out the invention is presented in terms of first, second, third, and fourth embodiments, with several design configurations.

### First Embodiment

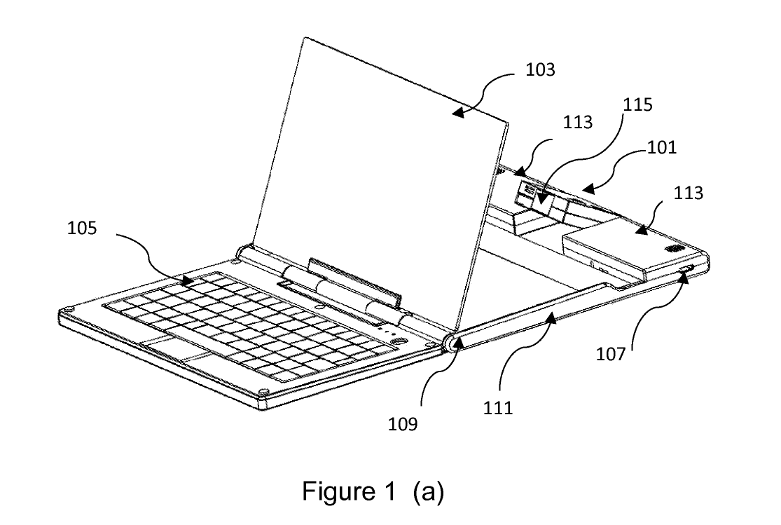

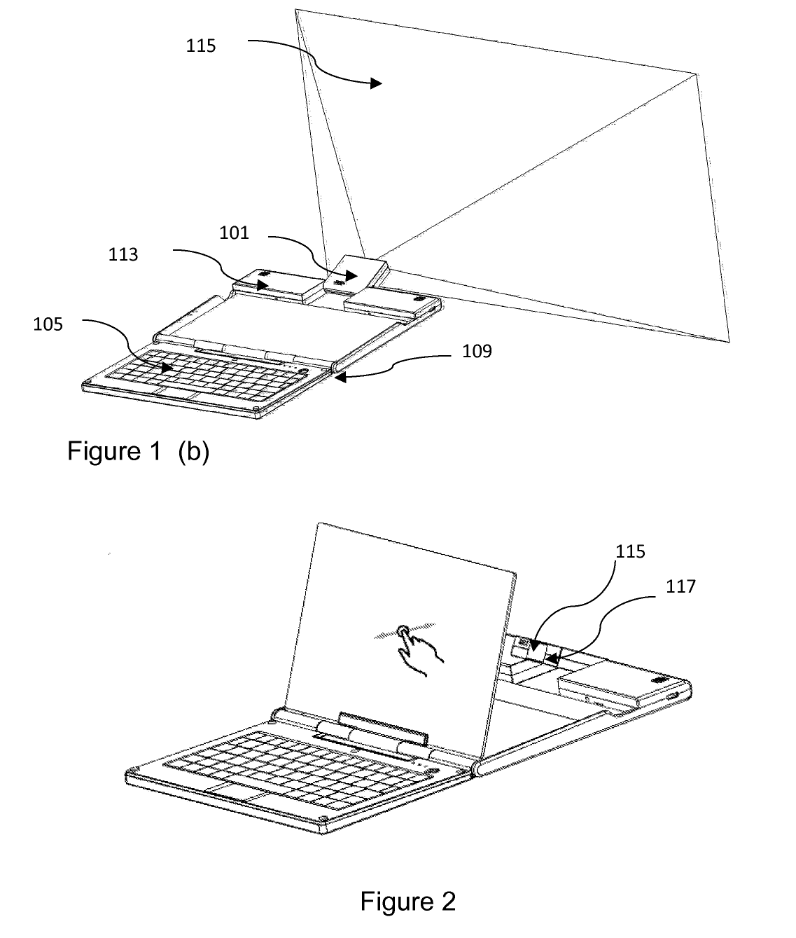

As shown in FIG. 1, the first embodiment of the apparatus is comprised of a projection device 101, a built-in rear or front projection screen 103, input device 105, and a wired or wireless connector 107 for input and output signal from and to a portable electronic device, preferably a smartphone. When the apparatus and smartphone are connected, the smartphone outputs its screen to the projection device 101. The apparatus comprises a receiver which receives video signals from said portable electronic device. The signal represents mirroring image of the display screen on the portable electronic device. Said projection device produces a screen much larger than that provided on the smartphone display. The input device 105 also is connected with the smartphone via hard wire or wireless. The user can use said input device to input information conveniently to the smartphone. Said input device could be a traditional mechanical keyboard, a keyboard based on touch screen technology, or projection keyboard based on image sensor technology. Said input device may further comprise of a touchpad, tracking ball or other similar device for data input to the smartphones.

The connections for video and data between said apparatus and the smartphone can be physical hard wire or wireless connection. The wireless connection may be based on any technology known to those skilled in the art such as bluetooth technology and WiFi technology.

Said projection device 101 further is characterized by dual operational modes whereby in the first projection mode, the image is projected onto the built-in screen which may be a rear or front projection screen, and in the second projection mode, a normally much larger image is projected onto an external projection surface (115) which may comprise of a rear projection screen, a front projection screen or a wall or other surface with acceptable reflectance and scattering properties. The apparatus comprises either a mechanical means that can rotate the projection device at different angles or a mirror that can direct the light to different directions for the purpose of switching between the first and second modes of projection. Said projection device 101 may further comprise a sensor that can detect the rear or front projection mode and modify the output image accordingly.

The apparatus comprises mechanical part 109 and 111 to ensure components from 101 to 107 are at their respective proper position in the operational stage. The mechanical parts also ensure components from 101 to 107 are packaged together into a small footprint in the closed stage for portability. In one embodiment, 109 is a hinge. In the closed stage, the keyboard 105 can be folded into the base 111 to reduce the size of the apparatus for portability.

In an alternative embodiment, said mechanical part 111 further comprises a sliding mechanism. Said sliding mechanism extends in the operational stage to keep the proper distance between the screen 103 and the projection device 101. When the apparatus is closed, said sliding mechanism returns back to original position to reduce the size of the apparatus in the non-operational stage.

In another embodiment as shown in FIG. 5, the apparatus comprises a mechanical part 507. 507 is designed such that the entire screen is raised above the level of the keyboard in the operational stage to ensure the proper distance and angle are established for the given parameters of the projection lens of the projector in the operational stage. When the apparatus is closed, 507 folds the screen 503 down to the top of the keyboard 505 and the projection device 501 to reduce the size of the apparatus in the non-operational stage.

In an alternative embodiment, said mechanical part 111 further comprises a mirror to fold the optical path between the projection device and screen to reduce the size of said apparatus in operational stage.

In one embodiment, the input device is detachable. For example, the keyboard may be detached when the input function is not intensively required or the user prefers to be at a further distance from the projection device. Under such a scenario, the projection device and input device operate independently and are provided power independently.

In one embodiment, the apparatus further comprises software and/or hardware to register the movement of the smartphone as an input method. As such, the user uses the smartphone as a mouse. The sensor inside the smartphone detects the movement of the smartphone. Said movement of the smartphone is registered as position of a cursor. The cursor is displayed on the image produced by said apparatus.

In one embodiment, the apparatus comprises part 113 for battery, electronics driving board, and speakers.

In one embodiment, the projection screen 103 is of the type that can be rolled up or folded into a compact size to further reduce the carry-on size of the system.

Said projection device 101 comprises a projection lens 115. Typically, it comprises multiple lenses. The projection lens is specially design to produce a large image at short throw distance. Said projection lens is characterized as a short focal length lens. The throw ratio is defined as the throw distance over the width of the image. A lower throw ratio from 0.1 to 5 is preferred.

In one embodiment, the focal length of said projection lens is adjustable (zoomable) to accommodate the varying screen sizes between the first and seconde projection modes. The adjustability of the focal length may be the result of changing the position of the lenses in said projection lens or adding an add-on lens.

The power system may be configured to provide multiple power levels to the projection apparatus. For example, in the first projection mode, 1-3 watts of power may be sufficient to provide satisfactory luminance on the rear or front projection screen for the user. In the second projection mode, depending on ambient light and battery power level or availability of supplemental power, the user may elect to supply additional power to the light engine to allow for satisfactory brightness on the screen. The core advantages of the present invention include the flexibility of the dual purposed first and second projection mode display, multiple power level operation, light weight of the apparatus, and low cost.

In another embodiment, the power system may be configured to provide through a wired connection, such as USB, power to the smartphone for charging or power to a cable such as an MHL to HDMI converter cable providing the video input to the apparatus from the smartphone.

### Second Embodiment

FIG. 2 shows the second embodiment of the apparatus with a touch screen based on an image sensor where all numerals correspond to those elements previously described. The second embodiment of the apparatus further comprises an image sensor 117 near the projection lens 115. The image sensor may be a visual or IR image sensor based on CCD or CMOS technology. The image sensor detects the movement of the finger tip of the user. The position and movement of finger tip are used to input information.

### Third Embodiment

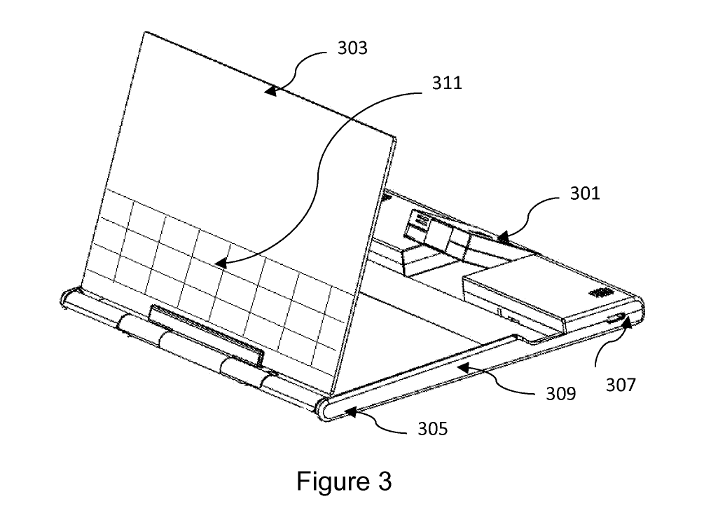

FIG. 3 shows the third embodiment of the apparatus with a keyboard based on touch screen. The third embodiment of the apparatus is comprised of a projection device 301, a built-in rear screen 303 and a wired or wireless connector 307 for input and output signal from and to a portable electronic device, preferably a smartphone. The rear projection screen also serves as a touch screen. When the apparatus and smartphone are connected, the smartphone outputs its screen to the projection device 301. The projection device 301 produces images on the built-in projection screen 303. 303 not only serves as a rear projection screen but also a touch input panel. The touch panel could base on any technology known to those skilled in the art such as resistive based touch screen or capacitive based touch screen. In an alternative embodiment, the touch screen is based on image sensor based CCD or CMOS technology as disclosed in second embodiment. Part of the image displayed 311 is a dynamic keyboard. User uses the touch keyboard to input information. The third embodiment of the apparatus is comprised of mechanical parts 305 and 309 ensuring all other components at right position. In one embodiment, 305 is a hinge so that 303 can be folded into to base 309 to increase the portability. The projection screen 303 may be of the type that can be rolled up or folded into a compact size to further reduce the carry-on size of the system.

### Fourth Embodiment

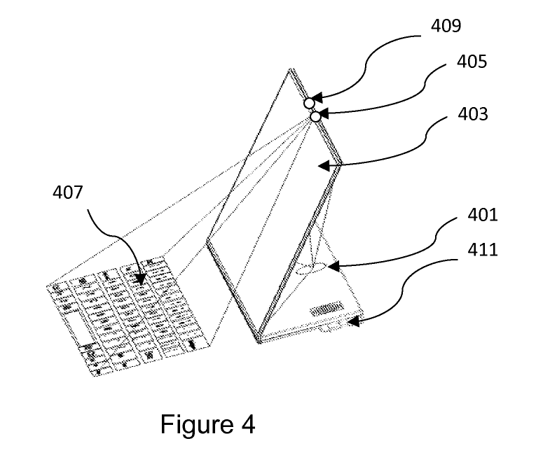

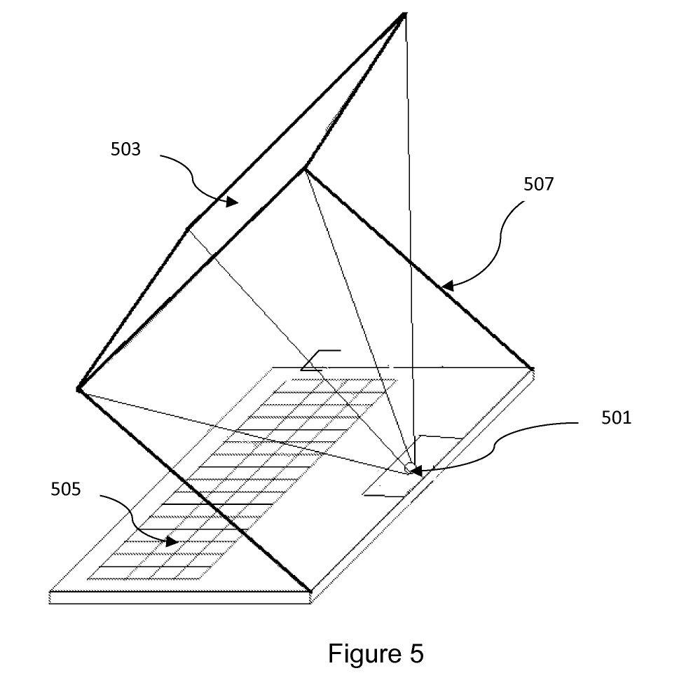

As shown in FIG. 4, the fourth embodiment of the apparatus is comprised of a projection device 401, a built-in rear or front projection screen 403, another projector 405 that can project a keyboard 407 on a surface, an image sensor 409 that can detect the movement of fingers, and a wired or wireless connector 411 for input and output signal from and to a portable electronic device, preferably a smartphone. This embodiment operates in the same manner as the first embodiment except that the input device is a projection keyboard rather than a physical keyboard. The projector 405 projects a keyboard 407 on a surface. The image sensor 409 detects the movement of fingers and registers the finger movement as input signal. Projector 405 is normally a lower resolution, lower brightness projector compared to projector 401.

1. A projection display apparatus comprising:
a. A projection device
b. A built-in projection screen
c. A power source
d. A receiver to receive video signals from a portable electronic device.

2. The projection display apparatus as specified in claim 1 wherein said portable electronic device is a smartphone.

3. The projection display apparatus of claim 1 further comprising a connection to provide power to said portable electronic device from said power source.

4. The projection display apparatus of claim 1 further comprising:
a. An input device to provide input to said portable electronic device
b. A wired or wireless connector capable of transferring input from said input device to said portable electronic device.

5. The projection display apparatus as specified in claim 1 wherein said video signals represent a mirrored image from the display on said portable electronic device.

6. The projection display apparatus as specified in claim 1 comprising a mechanism to redirect the projection image generated by said projection device to enable switching of projection either to the built-in screen or to an external screen or surface.

7. The projection display apparatus as specified in claim 1 comprising a mirror to redirect the projection image generated by said projection device to enable switching of projection either to the built-in screen or to an external screen or surface.

8. The projection display apparatus as specified in claim 1 wherein said built-in screen is a rear projection screen.

9. The projection display apparatus as specified in claim 1 wherein said input device comprises a mechanical keyboard and touchpad.

10. The projection display apparatus as specified in claim 1 wherein said input device is a touch screen keyboard.

11. The projection display apparatus as specified in claim 1 wherein said input device comprises a projection keyboard and an image sensor to register the movement of user's fingers.

12. The projection display apparatus as specified in claim 1 wherein said built-in screen is also a touch panel.

13. The projection display apparatus as specified in claim 1 further comprising of an image sensor to register the movement of user's finger.

14. The projection display apparatus as specified in claim 1 wherein said input device is the touch panel specified in claims 9 and 10.

15. The projection display apparatus as specified in claim 1 further comprising a means to register the movement of the smartphone as an input method.

16. The projection display apparatus as specified in claim 1 wherein said projection device is further comprised of a projection lens with short focal length wherein the throw ratio of said projection lens varies from 0.1 to 5.

17. The projection display apparatus as specified in claim 1 wherein said projection device is further comprised of a projection lens wherein the focal length of said projection lens is variable for different use modes.

18. The projection display apparatus as specified in claim 1 wherein the said projection device receives a video signal from said portable electronic device via wired cable or wireless connection.

19. The projection display apparatus as specified in claim 1 wherein said input device communicates with said portable electronic device via wired cable or wireless connection.

20. The projection display apparatus as specified in claim 1 further characterized by not including a CPU and operating system.

21. The projection display apparatus as specified in claim 1 further comprising a battery.

22. The projection display apparatus as specified in claim 1 further comprising a speaker.

23. A projection display apparatus comprising:
a. A projection device
b. A built-in projection screen
c. A power source
d. A receiver to receive video signals
e. A method to redirect the projection image generated by said projection device to enable switching of projection either to the built-in screen or to an external screen or surface.
